(19) United States
(12) Patent Application Publication
(10) Pub. No.: US 2022/0314697 A1
(43) Pub. Date: Oct. 6, 2022

(54) VEHICLE TIRE HAVING A BELT BANDAGE

(71) Applicant: Continental Reifen Deutschland GmbH, Hannover (DE)

(72) Inventor: Wolfgang Reese, Peine (DE)

(73) Assignee: Continental Reifen Deutschland GmbH, Hannover (DE)

(21) Appl. No.: 17/596,261

(22) PCT Filed: Jun. 12, 2020
(86) PCT No.: PCT/EP2020/066409

§ 371 Date: Dec. 6, 2021

(30) Foreign Application Priority Data
Jun. 19, 2019 (DE) 10 2019 208 984.4

(51) Int. Cl. B60C 9/20; B60C 9/00

(52) U.S. Cl. CPC B60C 9/2009; B60C 9/0042; B60C 9/005; B60C 2009/2077; B60C 2009/0092; B60C 2009/2096

(57) ABSTRACT

The present invention relates to a vehicle tire comprising a belt bandage, wherein the belt bandage comprises strength members, wherein the strength members comprise hybrid cords arranged parallel to one another within the ply, and wherein the hybrid cords each contain at least one yarn made of polyethylene terephthalate (PET) and at least one yarn made of polyamide.

According to the invention the PET of the yarn of the hybrid cord of the belt bandage is recycled PET (rPET).

The present invention relates to a vehicle tire comprising a belt bandage, wherein the belt bandage comprises strength members, wherein the strength members comprise hybrid cords arranged parallel to one another within the ply, and wherein the hybrid cords each contain at least one yarn made of polyethylene terephthalate (PET) and at least one yarn made of polyamide.

Strength members for reinforcing various elastomeric products are well known. It is thus known that pneumatic vehicle tires can use a belt bandage which is configured with one or more layers and which covers the belt edges and comprises strength members running substantially in the circumferential direction in the form of cords embedded in the rubber. This belt bandage has the purpose, in particular in high-speed use, of preventing the tire from undergoing a rise due to the centrifugal forces arising in operation.

During tire production the bandage is applied in the form of plies, strips or individual cords with strength members embedded in an unvulcanized rubber mixture which are wound or spooled onto the bandage. The strength members are embedded into rubber by a sheet of essentially parallel strength members in thread form, which are generally pretreated thermally and/or with impregnation for better adherence to the embedding rubber in a manner known to those skilled in the art, passing in the longitudinal direction through a calender or an extruder for sheathing with the rubber mixture. In the course of shaping with existing apparatus and the vulcanization of the tire, the tire generally expands in the shoulder region, due to the rise, by up to 2% and in the center region by up to 4% compared with the unvulcanized green tire when the green tire is wound on a flat drum. With more recent building drums, strain during tire production is required to be still lower at about not more than 2%. The rise is lower with more modern devices. A further problem is the shrinkage behavior of the particular cord material at elevated temperature. Relatively low shrinkage requires relatively high dimensional stability of the vehicle tire and therefore better flatspot behavior, this being an expression known to those skilled in the art (=reversible plastic flattening in the area in contact with the ground when parked).

The cords of the bandage are intended to allow sufficient rise during the shaping process and in the vulcanizing mold during tire production to allow the tire to be precisely molded, and are intended to ensure good high-speed capability in operation after completion of the tire. To meet these requirements, the cords should be extendable up to a strain of about 3% to 4% under a moderate force and to a higher strain only under a very high force.

U.S. Pat. No. 7,252,129 B2 discloses a hybrid cord consisting of aramid fibers and a further fiber selected from the group consisting of polyester, nylon and rayon. This hybrid cord ensures relatively low separation of the individual threads of the reinforcement layer.

KR 100829260 B1 and KR 100829261 describe hybrid cords made of PET (polyethylene terephthalate) and nylon which are end-twisted together at 270 to 330 t/m (330 turns per meter) and double dipped. Compared to a single dipped cord made of nylon, this results in a reduction in strain at 45 N and a lower shrinkage at 180° C. The effect on shrink force is not apparent from these documents.

Hybrid cords made of polyester and polyamide are also described in WO 2014/001039 A1, WO 2015/137901 A1 and WO 2017/048208 A1.

WO 2011/147635 Al discloses the use of recycled PET, in particular in the carcass ply of vehicle tires.

The problem addressed by the present invention is that of providing a vehicle tire of the type specified at the outset comprising a belt bandage which exhibits a further improvement in shrinkage behavior and thus especially improved high-speed behavior. At the same time, the tire shall be produced as sustainably as possible and exhibit an improvement in rolling resistance properties.

This problem is solved when the PET is recycled PET (rPET).

It has surprisingly been found that with recycled PET as a strength member a further improvement in shrinkage behavior (greater shrinkage) is achieved compared to PET originally produced from crude oil, i.e. non-recycled PET, and improved properties are achieved in the belt bandage of the vehicle tire according to the invention: The vehicle tire according to the invention has improved high-speed capability. Possible cord compressions at the belt edge occur only to a markedly reduced extent, if at all, thus resulting in fewer cord breakages.

In addition, the use of recycled PET has ecological and economic advantages. It avoids the production of new (non-recycled) petroleum-based materials, thus avoiding overexploitation of the finite resource of crude oil.

In the context of the present invention “recycled PET” is to be understood as meaning PET which has been obtained, in particular by remelting, from end-of-life PET products such as PET bottles or other PET articles. This does not entail significant decomposition and reconstruction of the polymers. The direct starting material for recycled PET is not crude oil but bottles or other articles made of PET.

In the context of the present invention cords are linear constructs consisting of two or more yarns twisted together. A hybrid cord is a cord where two or more different yarns are twisted together. In the context of the present invention a yarn is a linear construct consisting of individual filaments or fibers as per DIN 60900.

The unit “dtex” is known to those skilled in the art and is a measure of the weight per unit length.

The lower the fineness in dtex, the lighter the corresponding yarn or cord.

In an advantageous embodiments of the invention the yarn made of recycled PET has a fineness of 200 to 1670 dtex, preferably 200 to 1350 dtex.

Such finenesses of the yarn made of recycled PET in the hybrid cord in the belt bandage of the tire according to the invention achieve particularly good high-speed capabilities while simultaneously reducing weight and thus improving rolling resistance.

In advantageous embodiments of the invention the yarn made of polyamide has a fineness of 200 to 1400 dtex, preferably 200 to 1000 dtex.

Such finenesses of the polyamide yarn in the hybrid cord in the belt bandage of the tire according to the invention achieve particularly good high-speed capabilities while simultaneously reducing weight and thus improving rolling resistance also in comparison to cords made of 100% by weight nylon inter alia.

In advantageous embodiments of the invention the hybrid cord of the belt bandage altogether has a fineness (overall fineness) of 400 to 3100 dtex, preferably 400 to 2900 dtex, particularly preferably 400 to 2200 dtex.

Such overall finenesses of the hybrid cord in the belt bandage of the tire according to the invention achieve particularly good high-speed capabilities while simultaneously reducing weight and thus improving rolling resistance.

In advantageous embodiments of the invention the yarn made of recycled PET and the yarn made of polyamide are end-twisted together to form the hybrid cord at 200 to 700 t/m, preferably 300 to 600 t/m. This results in very good fatigue resistance, thus endowing the tire with very good durability.

In preferred embodiments the cord thread density of the belt bandage is 50 to 150 epdm, particularly preferably 50 to 120 epdm. This density ensures sufficient strength when used in pneumatic tires.

The use according to the invention of rPET and polyamide in the belt bandage makes it possible to reduce the number of cords based on the tire width (epdm=ends per decimeter) and/or the ply thickness, which in turn entails rolling resistance advantages. At this same time, this achieves higher dimensional stability and thus improved flatspot behavior.

In a particularly advantageous embodiment of the invention the yarn made of recycled PET has a fineness of 1000 to 1200 dtex and the yarn made of polyamide has a fineness of 900 to 1000 dtex. This achieves particularly good properties for solving the problem addressed by the present invention, as also apparent from table 1 hereinbelow.

Here the yarn made of recycled PET and the yarn made of polyamide are preferably end-twisted together to form the hybrid cord at 300 to 380 t/m. This achieves very good fatigue resistance.

Here the cord thread density in the belt bandage is preferably 50 to 150 epdm, particularly preferably 70 to 120 epdm.

Adapting the cord thread density to the finenesses achieves optimal properties in terms of the technical problem and in particular the high-speed capability, dimensional stability—and thus flatspot behavior—and rolling resistance behavior.

In a further particularly advantageous embodiment of the invention the yarn made of recycled PET has a fineness of 200 to 360 dtex and the yarn made of polyamide has a fineness of 200 to 360 dtex. This achieves particularly good properties for solving the problem addressed by the present invention, as also apparent from table 2 hereinbelow. These finenesses simultaneously achieve in particular very thin plies in belt bandages of vehicle tires according to the invention. This further optimizes rolling resistance behavior.

Here the yarn made of recycled PET and the yarn made of polyamide are preferably end-twisted together to form the hybrid cord at 500 to 600 t/m. This achieves very good fatigue resistance.

Here the cord thread density in the belt bandage is preferably 100 to 150 epdm, particularly preferably 110 to 130 epdm.

Adapting the cord thread density to the finenesses achieves optimal properties in terms of the technical problem and in particular the high-speed capability, dimensional stability—and thus flatspot behavior—and rolling resistance behavior.

In a further particularly advantageous embodiment of the invention the yarn made of recycled PET has a fineness of 700 to 800 dtex and the yarn made of polyamide has a fineness of 680 to 780 dtex. This achieves particularly good properties for solving the problem addressed by the present invention. These finenesses too make it possible, compared to cords made of 100% by weight nylon inter alia, to achieve thinner plies in belt bandages of vehicle tires according to the invention. This further optimizes rolling resistance behavior.

Here the yarn made of recycled PET and the yarn made of polyamide are preferably end-twisted together to form the hybrid cord at 350 to 450 t/m. This achieves very good fatigue resistance.

Here the cord thread density in the belt bandage is preferably 50 to 80 epdm.

Adapting the cord thread density to the finenesses achieves optimal properties in terms of the technical problem and in particular the high-speed capability, dimensional stability—and thus flatspot behavior—and rolling resistance behavior.

In a further particularly advantageous embodiment of the invention the yarn made of recycled PET has a fineness of 500 to 600 dtex and the yarn made of polyamide has a fineness of 430 to 530 dtex. This achieves particularly good properties for solving the problem addressed by the present invention. These finenesses too make it possible, compared to cords made of 100% by weight nylon inter alia, to achieve thinner plies in belt bandages of vehicle tires according to the invention. This further optimizes rolling resistance behavior and achieves elevated dimensional stability.

Here the yarn made of recycled PET and the yarn made of polyamide are preferably end-twisted together to form the hybrid cord at 400 to 500 t/m. This achieves very good fatigue resistance.

Here the cord thread density in the belt bandage is preferably 70 to 100 epdm.

Adapting the cord thread density to the finenesses achieves optimal properties in terms of the technical problem and in particular the high-speed capability, dimensional stability—and thus flatspot behavior—and rolling resistance behavior.

The polyamide of the polyamide yarn is selected from the group consisting of polyamide 6 (PA 6), polyamide 66 (PA 66), polyamide 12 (PA 12), polyamide 11 (PA 11), polyamide 1313 (PA 1313), polyamide 4 (PA 4), polyamide 7 (PA 7), polyamide 8 (PA 8), polyamide 9 (PA 9), polyamide 46 (PA 46), polyamide 610 (PA 610), polyamide 612 (PA 612), polyamide 69 (PA 69) and polyamide 66/6 (PA 66/6).

The use of PA 6 and/or PA 66 is preferred, the use of PA 66 (nylon) being particularly preferred.

Using PA 66 as the material of the polyamide yarn results in a particularly good properties with regard to the problem addressed.

In advantageous embodiments of the invention the weight fraction of recycled PET in the hybrid cord is 40% to 60%. This provides an optimal solution to the problem addressed by the present invention and the hybrid cord comprises a significant proportion of sustainable material in the form of the recycled PET.

To ensure reliable adhesion of textile strength members to the rubber it is advantageous to provide the hybrid cord with an adhesive impregnation for ensuring adhesion of the strength members to the rubber. This adhesive impregnation may be effected for example with an RFL dip (resorcinol-formaldehyde-latex) in a 1- or 2-bath process. However, all further processes and adhesives known to those skilled in the art for impregnation, such as especially dips that are free from resorcinol and formaldehyde, are also conceivable.

In addition, further and customary pretreatment processes known to those skilled in the art may also be performed, such as in particular a hot stretching of the cord.

The belt bandage is preferably configured as a single-ply or multi-ply bandage at an angle between 0° and 5° to the circumferential direction, wherein a single-ply bandage is particularly preferred. In this connection “configured” is to be understood as meaning that said bandage is spooled in the circumferential direction in single-ply or multi-ply fashion, preferably single-ply fashion.

The yarn of recycled PET may be twisted in the S or Z direction.

The polyamide yarn may be twisted in the S or Z direction.

The yarns advantageously have the same twist direction. It is thus preferable when both are twisted either in the S direction or in the Z direction.

The twist direction to form the hybrid cord is advantageously opposite to the twist direction of the yarns. This results as a consequence of production in an improved and more constant quality in terms of the strength of the cords and thus of the belt bandage.

Working examples and further advantages of the present invention are more particularly elucidated with reference to tables 1 and 2 hereinbelow.

The inventive examples are marked “E” and are exemplary and particularly advantageous constructions of hybrid cords of the belt bandage of the vehicle tire according to the invention.

Employed as references are a cord made of nylon typically used in the belt bandage of vehicle tires and a hybrid cord made of virgin PET and PA 6.6.

Measurements were performed according to the following methods:
Breaking force and elongation at break, force and tensile strength at 4% and 6% strain, strain at 45 N, shrinkage at 180° C. and shrink force according to ASTM D 855

The reported properties in the unit N/dm each relate to the measured properties at the cord which were each extrapolated with the possible numbers of cords in the belt bandage per unit tire width (epdm=ends per decimeter) likewise specified in the tables.

TABLE 1

| | | | Ref. 2 ^{b)} Hybrid cord | E1 ^{c)} Hybrid cord |
|---|---|---|---|---|
| | | Ref. 1 ^{a)} PA 66 | PET 1100 × 1/PA 66 | rPET 1100 × 1/PA 66 |
| | | 1400 × 2 290 t/m | 940 × 1 340 t/m | 940 × 1 340 t/m |
| Property | Unit | End twist | End twist | End twist |
| Breaking force | N | 226 | 139 | 141 |
| Elongation at 45N | % | 5.9 | 3.6 | 3.9 |
| Force (4% strain) | N | 30 | 50 | 48 |
| Force (4% strain) | N/dm | 3300 | 4000 | 3840 |
| Tensile strength | mN/dtex | 10.7 | 24.5 | 23.5 |
| (4% strain) | | | | |
| Force (6% strain) | N | 46 | 78 | 76 |
| Force (6% strain) | N/dm | 5060 | 6240 | 6080 |
| Tensile strength | mN/dtex | 16.4 | 38.2 | 37.3 |
| (6% strain) | | | | |
| Elongation at break | % | 19 | 11 | 12 |
| Shrinkage at 180° C. | % | 5.0 | 5.2 | 6.3 |
| Diameter | mm | 0.64 | 0.57 | 0.57 |

^{a)} PA 66: Nylon, single yarn, twist direction Z; cord PA 66 1400 × 2 twist direction S.
^{b)} non-recycled PET and PA 66 yarn, both twist direction Z, Hybrid cord PET 1100 × 1/PA 66 940 × 1 twist direction S
^{c)} rPET: recycled PET; rPET and PA 66 yarn both twist direction Z, Hybrid cord rPET 1100 × 1/PA 66 940 × 1 twist direction S

Table 1 shows that the hybrid cord made of recycled PET and polyamide (E1) present according to the invention in the belt bandage surprisingly exhibits greater shrinkage than a cord made of PA 66 and non-recycled PET (Ref. 2). The surprisingly markedly improved shrinkage behavior of the hybrid cord in the belt bandage results in improved high-speed capability in vehicle tires. Possible cord compressions at the belt edge occur only to a markedly reduced extent, if at all, thus resulting in fewer cord breakages.

Compared to a standard cord made of nylon for the prior art belt bandage (Ref. 1) greater forces and tensile strengths are found at 4% and 6% strain.

Thus, the strength members in the belt bandage may be employed with a smaller diameter and in a smaller number (relative to tire width). As indicated in table 1, starting from 110 epdm of standard cords made of nylon, a hybrid cord made of PET and nylon allows the number to be reduced and the abovementioned improved properties to be achieved with 80 epdm for example despite the lower epdm.

Due to the smaller number of cords the individual cords can be arranged at a greater distance from one another in the belt bandage. This results in fewer shear stresses in the surrounding rubber matrix, which in turn results in improved durability.

At the same time this leads to better flatspot behavior, and thus improved dimensional stability, since there is altogether less shrinking material arranged in the tire.

The smaller diameter of the cords compared to Ref. 1 allows the belt bandage to be made thinner overall and less rubber mixture is also required. This improves the rolling resistance behavior of the tire according to the invention.

The fineness and thus the weight per unit length of the hybrid cord is also reduced. While Ref. 1 has a total fineness of 2800 dtex, said fineness is 2040 dtex with the exemplary construction from PET and nylon. The weight saving improves the rolling resistance behavior of the tire according to the invention.

The advantages that result from the lower weight, the smaller number and the smaller diameter do apply to non-recycled PET and to recycled PET. However, the stated elevated shrinkage with the advantages associated therewith is achieved only with the recycled PET (invention).

E2 is a further inventive example with a fineness which is markedly lower again and advantages in terms of rolling resistance that are further associated therewith. As is apparent in table 2 this too achieves the advantages as described for E1 relative to the respective references.

Therefore this construction too improves the properties of shrinkage and tensile strength that are important for the belt bandage.

The use of recycled PET is therefore environmentally friendly and resource-efficient. In addition, recycled PET has a uniform quality similarly to PET obtained directly from fossil raw materials. Consistent product quality can therefore be ensured.

In further exemplary embodiments the hybrid cord made of recycled PET and polyamide present according to the invention in the belt bandage has the following constructions: E3: Hybrid cord rPET 720×1/PA 66 700×1, 400 t/m end twist, 60 epdm E4: Hybrid cord rPET 550×1/PA 66 470×1, 470 t/m end twist, 80 epdm

In both E3 and E4 each individual yarn is twisted in the Z direction and the two hybrid cords are each twisted in the S direction.

TABLE 2

| | | | Ref. 4 ^{e)} Hybrid cord | E2 ^{f)} Hybrid cord |
|---|---|---|---|---|
| | | Ref. 3 ^{d)} PA 66 | PET 225 × 1/PA 66 | rPET 225 × 1/PA 66 |
| | | 470 × 2 420 t/m | 235 × 1 550 t/m | 235 × 1 550 t/m |
| Property | Unit | End twist | End twist | End twist |
| Breaking force | N | 73 | 30 | 31 |
| Elongation at 45N | % | 5.9 | 3.6 | |
| Force (4% strain) | N | 12 | 14 | 13 |
| Force (4% strain) | N/dm | 1560 | 1680 | 1560 |
| Tensile strength | mN/dtex | 12.8 | 30.4 | 28.3 |
| (4% strain) | | | | |
| Force (6% strain) | N | 18 | 20 | 19 |
| Force (6% strain) | N/dm | 2340 | 2400 | 2280 |
| Tensile strength | mN/dtex | 19.1 | 43.5 | 41.3 |
| (6% strain) | | | | |
| Elongation at break | % | 18 | 14 | 15 |
| Shrinkage at 180° C. | % | 5.0 | 5.3 | 6.4 |
| Diameter | mm | 0.40 | 0.25 | 0.25 |
| epdm | | 130 | 120 | 120 |

^{d)} PA 66: Nylon, single yarn, twist direction Z; cord PA 66 470 × 2 twist direction S
^{e)} PET and PA 66 yarn, twist direction Z, Hybrid cord PET 225 × 1/PA 66 235 × 1 twist direction S
^{f)} rPET and PA 66 yarn both twist direction Z, Hybrid cord rPET 225 × 1/PA 66 235 × 1 twist direction

1.-10. (canceled)

11. A vehicle tire comprising a belt bandage, wherein the belt bandage comprises strength members, wherein the strength members comprise hybrid cords arranged parallel to one another within a ply, wherein the hybrid cords each contain at least one yarn made of polyethylene terephthalate (PET) and at least one yarn made of polyamide, and wherein the PET is recycled PET (rPET).

12. The vehicle tire as claimed in claim 11, wherein the yarn made of recycled PET has a fineness of from 200 dtex to 1670 dtex.

13. The vehicle tire as claimed in claim 12, wherein the yarn made of recycled PET has a fineness of from 200 dtex to 1350 dtex.

14. The vehicle tire as claimed in claim 11, wherein the yarn made of polyamide has a fineness of from 200 dtex to 1400 dtex.

15. The vehicle tire as claimed in claim 14, wherein the yarn made of polyamide has a fineness of from 200 dtex to 1000 dtex.

16. The vehicle tire as claimed in claim 11, wherein the hybrid cord altogether has a fineness of from 400 dtex to 3100 dtex.

17. The vehicle tire as claimed in claim 16, wherein the hybrid cord altogether has a fineness of from 400 dtex to 2900 dtex.

18. The vehicle tire as claimed in claim 17, wherein the hybrid cord altogether has a fineness of from 400 dtex to 2200 dtex.

19. The vehicle tire as claimed in claim 11, wherein the yarn made of recycled PET and the yarn made of polyamide are end-twisted together to form the hybrid cord at from 200 t/m to 700 t/m.

20. The vehicle tire as claimed in claim 19, wherein the yarn made of recycled PET and the yarn made of polyamide are end-twisted together to form the hybrid cord at from 300 t/m to 600 t/m.

21. The vehicle tire as claimed in claim 11, wherein the yarn made of recycled PET has a fineness of from 1000 dtex to 1200 dtex and the yarn made of polyamide has a fineness of from 900 dtex to 1000 dtex.

22. The vehicle tire as claimed in claim 21, wherein the yarn made of recycled PET and the yarn made of polyamide are end-twisted together to form the hybrid cord at from 300 t/m to 380 t/m.

23. The vehicle tire as claimed in claim 11, wherein the yarn made of recycled PET has a fineness of from 200 dtex to 360 dtex and the yarn made of polyamide has a fineness of from 200 dtex to 360 dtex.

24. The vehicle tire as claimed in claim 11, wherein the polyamide is polyamide 66 (PA 66).

25. The vehicle tire as claimed in claim 11, wherein the weight fraction of the recycled PET in the hybrid cord is from 40% to 60%.

26. The vehicle tire as claimed in claim 11, wherein the hybrid cord has a shrinkage of greater 5.0% at 180° C.

27. The vehicle tire as claimed in claim 26, wherein the hybrid cord has a shrinkage of 5.2% or greater at 180° C.

28. The vehicle tire as claimed in claim 26, wherein the hybrid cord altogether has a fineness of from 400 dtex to 2200 dtex.

29. The vehicle tire as claimed in claim 26, wherein the yarn made of recycled PET has a fineness of from 200 dtex to 1350 dtex.

30. The vehicle tire as claimed in claim 26, wherein the yarn made of polyamide has a fineness of from 200 dtex to 1000 dtex.
